(19) United States
(12) Patent Application Publication
(10) Pub. No.: US 2006/0147845 A1
(43) Pub. Date: Jul. 6, 2006

(54) Electrically reconfigurable photolithography mask for semiconductor and micromechanical substrates

(76) Inventors: Kyle Y. Flanigan, Portland, OR (US); Baohua Niu, Portland, OR (US); Juan E. Dominguez, Hillsboro, OR (US); Ernisse S. Putna, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/029,776

(22) Filed: Jan. 5, 2005

(51) Int. Cl. G03C 5/00; G02F 1/13

(52) U.S. Cl. 430/322; 349/2; 430/394

(57) ABSTRACT

A mask useful for photolithography that can be electronically reconfigured is described. In one embodiment, a photolithography system has an illumination system, a reticle scanning stage, a wafer scanning stage, and a reticle mounted to the reticle scanning stage, the reticle having an electronically reconfigurable mask.

### BACKGROUND

1. Field

The present description relates to the field of masks for semiconductor and micromechanical photolithography, and in particular to a mask that can be reconfigured electronically.

2. Background

Semiconductor chips are typically made using a process of photolithography. In this process, a layer of photoresist is spun onto a semiconductor die or substrate as a single uniform layer. A light, for example from a laser, is projected onto the photoresist through a mask. The mask has a pattern that causes the photoresist to be illuminated only in certain parts corresponding to the pattern. After exposure, the photoresist is developed to reproduce the mask's pattern on the photoresist. This relic of the mask on the photo resist serves as a mask or as protection for subsequent processing, such as etching and implanting, that transfer the pattern onto the substrate. After the pattern transfer from the photoresist to the substrate is completed, the photoresist is removed, leaving the pattern for the metal, silicon, oxide or any other substrate materials. By repeating the process of applying photoresist, exposing, developing, etching and removing the photoresist, layers of complex circuitry or structures can be formed.

In the process of forming a complex electronic circuit or micro-machine layer by layer, the mask must be changed for each layer. In a typical processing system, the processing chamber must be vented and opened and either the substrate must be moved to another chamber with a different mask or the mask must be removed and replaced with another mask. In either case, the substrate and the mask are exposed to contaminants and injury from the handling. The process of changing masks or chambers also slows down the fabrication process. In a conventional semiconductor circuit of modest complexity, it is not uncommon to use a dozen different masks. For complex semiconductors or electronic circuits, there could be as many as 40 masks to make up the finished circuits.

Mask making itself is an expensive and tedious process that involves using an electron beam machine as a writer to transfer the designed pattern on to a quartz plate as a chromium pattern. The quartz glass is transparent and the chrome is opaque or even reflective. When a light shines on the mask, the pattern between the chromium features is transferred to the photoresist.

Due to the very small size of the features that are transferred to the photoresist, even a very small speck of dust or other particle on the mask can significantly affect the pattern on the photoresist. The chromium coating is also degraded by exposure to the light used in photoresist, for current state of art scanners, a deep ultraviolet (DUV) scanning laser is used. The mask must be inspected frequently to make sure that it is free of particles and in good condition. Inspections are scheduled based on the number of times that the mask is exposed under laser irradiation and removed from a chamber and replaced. Inspections and cleaning also add costs and manufacturing delays.

One further risk of replacing a mask or a wafer is that the mask, light source and wafer must be precisely aligned. This ensures that the next pattern on the substrate is aligned with the last pattern on the substrate so that all of the elements on the chip connect and operate as intended. The alignment process creates additional delay and complexity for the process and, if not performed correctly, will destroy the chip.

### BRIEF DESCRIPTION OF THE DRAWINGS

Embodiments of the present invention will be understood more fully from the detailed description given below and from the accompanying drawings of various embodiments of the invention. The drawings, however, should not be taken to be limiting, but are for explanation and understanding only.

FIG. 1 is a diagram of a laser scanning photolithography stepper suitable for use with an embodiment of the present invention;

FIG. 2 is a cross-sectional diagram of a liquid crystal photomask according to an embodiment of the present invention;

FIG. 3 is a perspective view diagram of the photomask of FIG. 2; and

FIG. 4 is a process flow diagram of forming layers on a substrate using photolithography according to an embodiment of the invention.

### DETAILED DESCRIPTION

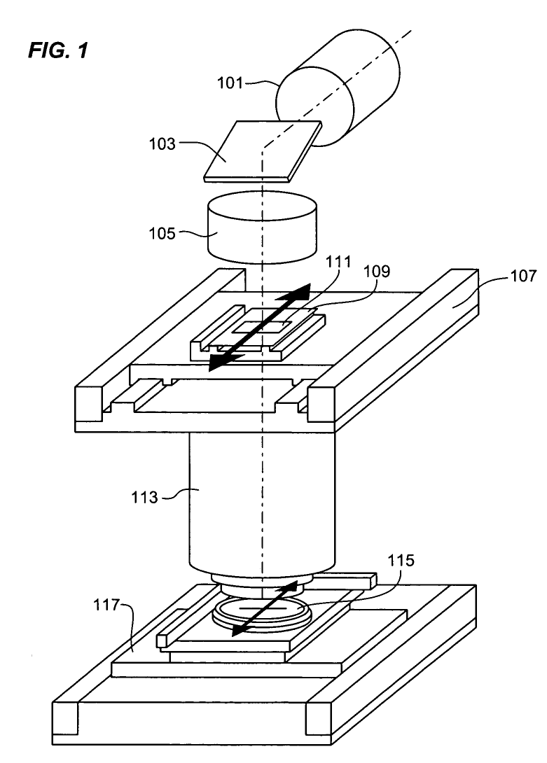

FIG. 1 shows a conventional semiconductor fabrication machine, in this case, a lens-scanning ArF Excimer Laser Scanner. The scanner may be enclosed in a sealed vacuum chamber (not shown) in which the pressure, temperature and environment need to be precisely controlled. The scanner has an illumination system including a light source 101, such as an ArF excimer laser, a scanning mirror 103, and a lens system 105 to focus the laser light on the wafer. A reticle scanning stage 107 carries a reticle 109 which holds the mask 111. The light from the laser is transmitted onto the mask and the light transmitted through the mask is focused further by a projection lens with, for example a four fold reduction of the mask pattern onto the wafer 115.

The wafer is mounted to a wafer scanning stage 117. The reticle scanning stage and the wafer scanning stage are synchronized to move the reticle and the wafer together across the field of view of the laser. In one example, the reticle and wafer move across the laser light so that the laser light traces a thin line across the wafer, then the laser steps down and the reticle and wafer move across the laser to trace another thin line until the entire surface of the reticle and wafer have been exposed to the laser. Such a step and repeat scanning system allows a high intensity narrow beam light source to illuminate the entire surface of the wafer. The stepper is controlled by a station controller (not shown) which may control the starting, stopping and speed of the stepper as well as the temperature, pressure and chemical makeup of the ambient environment, among other factors. The stepper of FIG. 1 is an example of a fabrication device that may benefit from embodiments of the present invention. Embodiments of the present invention may also be applied to many other photolithography systems.

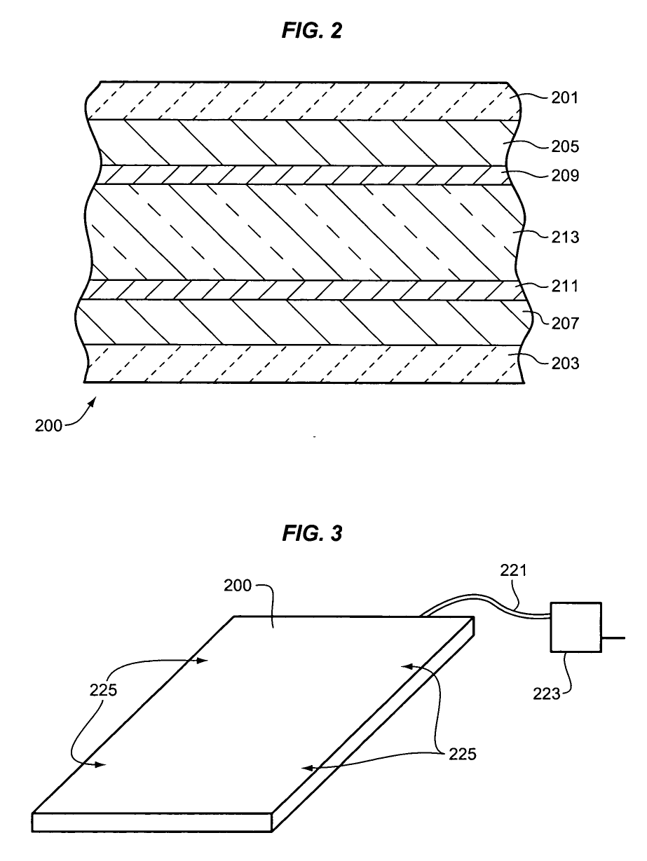

FIG. 2 shows an example of an electronically reconfigurable mask 200 that may be used as a replacement for a conventional quartz plate mask. Such a reconfigurable mask may be held by the reticle of FIG. 1 and controlled by the station controller. The reconfigurable mask has two polarized glass quartz panels 201, 203. The plates may be made of any material that is transparent to the light that will be used for the photolithography. In one embodiment, the light has a wavelength of 248 nm and in another embodiment, the light has a wavelength of 193 nm. Quartz glass is transparent to this and many other light wavelengths.

The two panels may be made of the same type of quartz glass material used in a conventional mask with etching applied to one or both sides as a polarization grating. The particular design of the polarization grating and materials selection may be optimized for the wavelength of the light that will be transmitted through the mask. The plates may be arranged so that the polarization gratings are perpendicular to each other or the gratings may be parallel to each other with appropriate adjustments to the operation of the device. An electrode layer 205, 207 is applied to each of the glass plates to control the individual pixels of the mask. In one embodiment the two electrode layers are arranged in lines so that the lines of the upper layer 205 are perpendicular to those of the lower layer 207.

Alignment layers 209, 211 are positioned adjacent to the electrode layers to align liquid crystals 213 that are contained and sealed between the two alignment layers. In one embodiment, the polarization of the upper plate 201, the electrodes of the electrode layer 205, and the alignment layer 209 are all parallel to induce the liquid crystals near the upper alignment layer to also be aligned with the polarization of the glass plate. Accordingly, light that strikes the glass plate will be transmitted through the upper glass plate, electrodes, and liquid crystals in one polarization state. The corresponding lower glass plate, electrodes, alignment layers and nearby liquid crystals are perpendicular to the upper components so that the polarized state of light that passes through the top layers is rotated through a quarter circle (90 degrees) and passes through the other side of the liquid crystal (LC) panel. A voltage applied by the electrode layer to specific pixels disrupts this polarization rotation and blocks the light. Other LC configurations are possible.

As shown in FIG. 3, the electrode layers 205, 207 of the LC panel 200 are coupled to a set of leads 221 which are coupled to an appropriate driver 223. The driver converts image or other data into the appropriate pixel voltages for driving the liquid crystal picture elements. The driver allows the LC panel to generate an image by varying the transmission of light through the panel. The panel may be sized to be about the same size as a conventional glass and chrome mask, for example a square about 32 centimeters in length and width.

The glass plates may also have alignment marks or indices 225 to allow the reconfigurable mask to be precisely aligned with the reticle scanning stage. Alternatively, the alignment marks may be generated by the liquid crystals. This would allow the mask to be reconfigured for different steppers that use different alignment marks. It would also allow the alignment marks to be more easily aligned with the pixels of the liquid crystal grid.

The liquid crystal material may be made of any suitable liquid crystals that may be switched to control light of the desired wavelength that is used for photolithography. LCD (liquid crystal display) panels with resolutions as high as 6400 pixels per inch are commercially available. Such a panel has a distance of about 4 micrometers between the centers of adjacent pixels. Using the optical system of a conventional stepper, this provides a distance of 0.5 micrometers or 50 nanometers between pixels of the image projected onto a wafer. 50 nanometer resolution is sufficient for critical layers at a 90 nanometer photolithography node. Current state of the art microprocessors use a 90 nanometer process and further reductions in the process are likely to be met with further increases in LCD resolution. Many semiconductor and micromechanical devices use only features that are much larger than those of the current 90 nm microprocessor technology.

A variety of different commercially available liquid crystal materials may be used to create a mask applicable to different embodiments of the present invention, including azo-dye, doped, cellulose acetate polymers, polyimides and polyamides. In one embodiment, an SSTFLC (surface stabilized ferroelectric liquid crystal) polyimide co-polymer as shown in the below structure may be used. Polyimides such as SSTFLC are stable in high energy fields such as those caused by a high energy laser. For a scanning laser, the stability does not need to be maintained for more than a few milliseconds, because each area of liquid crystal is only exposed to the scanning laser for a short while. In this structure n and m may both be in the range of 10 to 100 and may be equal or unequal. The two substructures may alternate in sequence or follow a randomized pattern.

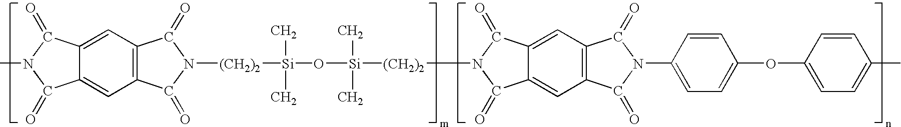

Each of the liquid crystal cells or pixels may be configured to be addressable by position. A conventional electrical grid made from inert conductive materials may be used to switch each cell. The electrical grid may be coupled through its driver 223 to the station controller to generate the desired pattern for transfer to the wafer.

In another embodiment, for a step-and-repeat scanning system, the mask may be large enough only for a single scan line of the scanning system. Such a configurable mask may be 32 cm long but only 6 mm wide. 6 mm is wide enough to accommodate a typical laser beam as it scans across the wafer. The specific dimensions of a reconfigurable mask in any embodiment herein may be modified as appropriate to suit any particular application.

To accommodate such a single line mask, the reticle scanning stage of the stepper may be adapted to move the mask with the laser optics, and to re-write the reticle after each scan line. A step and repeat scanning system steps the laser to the next line after each previous line is scanned. If the mask is also stepped and the pixels of the mask are rewritten to represent the new line, then the same LC panel mask may be used for each new line.

The electronically reconfigurable reticle allows multiple layers to be formed on a substrate without changing and realigning the reticle. It also allows for improvements to be made to the patterns of a mask without making new masks. While liquid crystal technology is described above as the basis for the reconfigurable mask other reconfigurable imaging technologies may also be used.

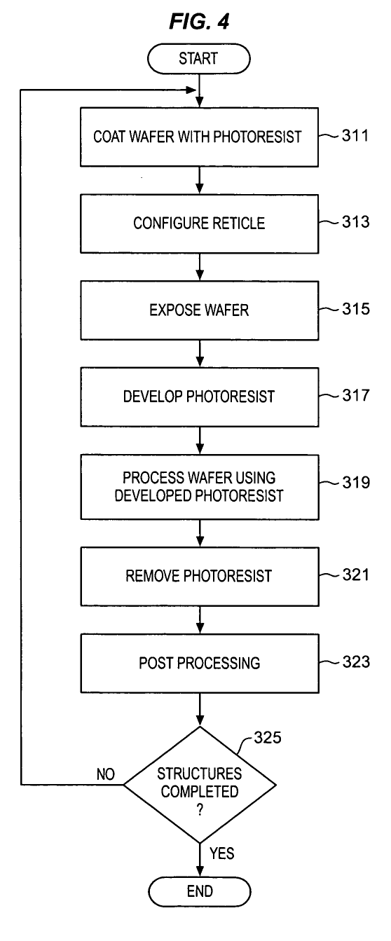

A portion of a production process according to one embodiment is shown in FIG. 4. In FIG. 4, a wafer has been placed in a processing chamber with a photolithography device, such as the stepper of FIG. 1. The stepper incorporates an electronically reconfigurable reticle, such as the LCD panel shown in FIG. 2. The wafer, at block 311 is first coated with a layer of photoresist. At block 313, the reticle is then configured with the desired mask pattern by, for example, sending a set of pixel signals to the reticle from a station controller. At block 315, the photoresist on the wafer is exposed by light, such as a scanning laser, through the reticle.

At block 317, the photoresist is developed and at block 319 the photoresist is used as a mask to transfer the pattern to the substrate by either etching or ion implant. The substrate may be silicon, an oxide, a metal, or any other substance that is sputtered, deposited or applied in some other way. The photoresist is then removed at block 321 and at block 323 any remaining residues are cleaned.

At block 325, the process returns to block 311 with a new layer of substrate and then a new layer of photoresist and a reconfiguration of the reticle to create a new pattern by exposure and development. The process of FIG. 4 may be repeated as many times as necessary until the entire structure has been formed. At each repetition, the reticle remains in the stepper without being replaced. When the wafer is removed so that a new wafer may be processed, the reticle may be serviced as necessary. This servicing may include cleaning, calibrating and realigning the liquid crystals.

Although the description of the various embodiments refers primarily to using a liquid crystal mask in conjunction with laser stepper, the various embodiments may also be used with other types of electrically reconfigurable mask panels and with other photolithography systems. The various embodiments may also be used to perform different photolithography processes than those described.

Embodiments of the present invention may be provided as a computer program product which may include a machine-readable medium having stored thereon instructions which may be used to program a control station, a microcontroller or other electronic device to perform a process. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media or machine-readable medium suitable for storing electronic instructions. Moreover, embodiments of the present invention may also be downloaded as a computer program product, wherein the program may be transferred from a remote computer or controller to a requesting computer or controller by way of data signals embodied in a carrier wave or other propagation medium via a communication link (e.g., a modem or network connection).

It is to be appreciated that a lesser or more complex reconfigurable mask, photolithography system, and photolithography process than the examples described above may be preferred for certain implementations. Therefore, the configurations and the processes may vary from implementation to implementation depending upon numerous factors, such as the nature of the layers to be formed on a substrate, processes to be used in forming the layers, performance requirements, technological improvements, or other circumstances. Embodiments of the invention may also be applied to other types of systems that use different fabrication processes than those shown in the Figures.

In the description above, numerous specific details are set forth. However, it is understood that embodiments of the invention may be practiced without these specific details. For example, well-known equivalent materials may be substituted in place of those described herein, and similarly, well-known equivalent techniques may be substituted in place of the particular reconfiguration and processing techniques disclosed. In other instances, well-known structures and techniques have not been shown in detail to avoid obscuring the understanding of this description.

While the embodiments of the invention have been described in terms of several embodiments, those skilled in the art will recognize that the invention is not limited to the embodiments described, but may be practiced with modification and alteration within the spirit and scope of the appended claims. The description is thus to be regarded as illustrative instead of limiting.

What is claimed is:

1. An apparatus comprising a reticle for photolithography having an electronically reconfigurable mask.

2. The apparatus of claim 1, wherein the mask comprises liquid crystal.

3. The apparatus of claim 1, wherein the mask comprises an electrically reconfigurable material layer sandwiched between two transparent plates and an electrical grid coupled to control individual pixels of the reconfigurable material.

4. The apparatus of claim 1, wherein the mask comprises a liquid crystal layer sandwiched between two plates and an electrical grid coupled to the liquid crystal layer to control individual pixels of the liquid crystal layer.

5. The apparatus of claim 4, wherein the two plates comprise polarizing surfaces.

6. The apparatus of claim 1, wherein the liquid crystal layer comprises a matrix of polyimide co-polymer.

7. The apparatus of claim 1, wherein the liquid crystal comprises a surface-stabilized ferroelectric liquid crystal.

8. The apparatus of claim 1, further comprising alignment marks on the mask to align it with a reticle scanning stage.

9. The apparatus of claim 1, wherein the mask is sized to accommodate no more than one exposure scan line of a scanning stepper light source.

10. An apparatus comprising:
an illumination system;
a reticle scanning stage;
a wafer scanning stage; and
a reticle mounted to the reticle scanning stage, the reticle having an electronically reconfigurable mask.

11. The apparatus of claim 10, wherein the mask comprises liquid crystal.

12. The apparatus of claim 10, wherein the mask comprises an electrically controlled panel with a plurality of picture elements that are alternately transparent or not transparent to light from the illumination system depending on the electric control.

13. The apparatus of claim 12, further comprising a station controller to control the reticle scanning stage, the wafer scanning stage and the mask.

14. A method comprising:
configuring pixels of a photolithography mask;
exposing a first photoresist on a substrate;
processing the exposed photoresist;
reconfiguring the pixels of the photolithography mask;
exposing a second photoresist on the substrate.

15. The method of claim 14, wherein configuring pixels comprises electronically configuring pixels using an external station controller.

16. The method of claim 14, wherein configuring pixels comprises setting pixels of a liquid crystal panel.

17. The method of claim 14, wherein configuring pixels comprises setting voltages at individual pixels of an electronic panel.

18. The method of claim 14, wherein reconfiguring pixels comprises changing voltages of individual pixels of the electronic panel.

19. The method of claim 14, wherein configuring pixels comprises programming an image into a liquid crystal display.

20. The method of claim 14, wherein processing comprises developing the photoresist, applying a layer of material on the substrate, and removing the photoresist.

21. The method of claim 14, further comprising spinning the second photoresist on the substrate after processing the exposed photoresist.

22. An article comprising a machine readable medium including data that when accessed by a machine causes the machine to perform operations comprising:
configuring pixels of a photolithography mask before a first photoresist on a substrate is exposed; and
reconfiguring the pixels of the photolithography mask after the first exposed photoresist is processed and before a second photoresist on the substrate is exposed.

23. The method of claim 22, wherein configuring pixels comprises electronically configuring pixels using an external station controller.

24. The method of claim 1, wherein configuring pixels comprises setting pixels of a liquid crystal panel.

25. The method of claim 22, wherein configuring pixels comprises setting voltages at individual pixels of an electronic panel.

26. The method of claim 22, wherein configuring pixels comprises programming an image into a liquid crystal display.

27. An semiconductor device fabricated using a reticle for photolithography having an electronically reconfigurable mask.

28. The device of claim 27, wherein the mask comprises an electrically reconfigurable material layer sandwiched between two transparent plates and an electrical grid coupled to control individual pixels of the reconfigurable material.

29. The device of claim 27, further comprising alignment marks on the mask to align it with a reticle scanning stage.
